(19) United States
(12) Patent Application Publication
(10) Pub. No.: US 2011/0007926 A1
(43) Pub. Date: Jan. 13, 2011

(54) HEADPHONE DEVICE

(75) Inventor: Katsunori Murozaki, Chiba (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/826,071

(22) Filed: Jun. 29, 2010

(30) Foreign Application Priority Data
Jul. 9, 2009 (JP) 2009-162941

(51) Int. Cl. H04R 1/02

(52) U.S. Cl. 381/374

(57) ABSTRACT

A headphone device includes: a driver unit held in the vicinity of the external acoustic meatus of an ear; and an arm in a predetermined shape formed integrally with the driver unit and extending from the driver unit, wherein an end of the arm is kept abutting on a part of the auricle near the base the auricle on a back side thereof to support the device at two support points provided by the driver unit and the end of the arm.

### BACKGROUND OF THE INVENTION

1. Field of the Invention

The present invention relates to a headphone device and, more particularly, the invention can be advantageously applied to a compact and lightweight headphone device which is used by connecting it to, for example, a portable audio player.

2. Description of the Related Art

As shown in FIG. 1, a so-called clip type headphone device 1 according to the related art includes a main body 2 incorporating a driver unit and a hanging type earpiece 3, and the device is held on an auricle of a user by sandwiching an upper part of the auricle with an upper part 3A of the hanging type earpiece 3.

As shown in FIG. 2, a so-called earlobe-mounded headphone device 5 includes a driver unit 6 and a substantially U-shaped ear-holding section 7 attached to the driver unit 6, and the device is held on a ear of a user by sandwiching the earlobe with the ear-holding section 7.

Further, as shown in FIG. 3, another earlobe-mounted headphone device 8 includes a driver unit 9 and an ear-holding section 10 which is integrally attached to the driver unit 9 and which has a substantially U-shaped end.

The earlobe-mounted headphone device 8 is held on a ear of a user by sandwiching the auricle or the earlobe with the ear-holding section 10.

Further, as shown in FIG. 4, an ear-hang headphone device 11 includes a driver unit 12 and a loop-shaped ear hanger 13 which is integral with the driver unit 12 and which is curved to extend along the outline of an auricle of a user (see JP-A-2009-55122 (Patent Document 1)).

A surface of a rear arm section 13A of the ear hanger 13 is substantially entirely in contact with the base region of an auricle on the rear side of the auricle, and a protruding section 13B formed below the rear arm section 13A fits in a recessed part of the contour of the base, whereby the ear-hang headphone device 11 is held.

### SUMMARY OF THE INVENTION

The above-described clip type headphone device 1 (FIG. 1) exerts a pressure to an upper part of an auricle because the device is constructed to sandwich the upper part of the auricle between the main body 2 and the upper part 3A of the hanging type earpiece 3, and the device therefore has a problem in that it can be painful for a user to wear the device for a long time.

The clip type headphone device 1 has such a structure that the distance between the main body 2 and the upper part 3A of the hanging type earpiece 3 cannot be adjusted to accommodate various shapes of auricles. Therefore, the clip type headphone device 1 has a problem in that it is difficult to wear the device for a user whose auricles do not fit the position of the upper part 3A of the hanging type earpiece 3 and in that the wearability of the device consequently becomes low because of loads imparted to an auricle itself.

When the pressure exerted by the main body 2 and the hanging type earpiece 3 of the clip type headphone device 1 is reduced, the main body 2 is mounted in an auricle with reduced stability. Then, a problem arise in that the device can no longer sufficiently function as a headphone and can become a mere decoration.

Further, the above-described earlobe-mounted headphone devices 5 and 8 (shown in FIGS. 2 and 3, respectively) have a problem in that it is painful for a user to wear the devices for a long time because a pressure is exerted on an earlobe of the user by the structure for sandwiching the earlobe of the user with the substantially U-shaped ear holding sections 7 and 10.

In the case of the above-described ear-hang headphone device 11 (FIG. 4), the size of the ear hanger 13 is fixed, and the device is therefore difficult to wear for a user for whom the ear hanger 13 is wrong-sized. As a result, the device has a problem in that it has low wearability because of loads imparted to an auricle of a user.

Under the circumstance, it is desirable to provide a headphone device which can be comfortably worn by any user with improved stability without giving the user a pain.

According to an embodiment of the invention, there is provided a headphone device including a driver unit held in the vicinity of the external acoustic meatus of an ear and an arm in a predetermined shape formed integrally with the driver unit and extending from the driver unit, wherein an end of the arm is kept abutting on a part of the auricle near the base of the auricle on a back side thereof to support the device at two support points provided by the driver unit and the end of the arm.

Thus, the headphone device can be mounted to any auricle regardless of its size and shape by supporting it at two points, i.e., the driver unit and the end of the arm. Therefore, the device can be worn by any user with a comfortable feel and high stability and without giving a pain.

According to the embodiment of the invention, since the headphone device can be mounted to any auricle regardless of its size and shape by supporting it at two points, i.e., the driver unit and the end of the arm, the device can be worn by any user with a comfortable feel and high stability and without giving a pain.

### BRIEF DESCRIPTION OF THE DRAWINGS

FIG. 1 is a schematic perspective view of a clip type headphone device according to the related art;

FIG. 2 is a schematic perspective view of an earlobe-mount type headphone device having a structure for pinching an earlobe according to the related art;

FIG. 3 is a schematic perspective view of another earlobe-mount type headphone device having a structure for pinching an earlobe according to the related art;

FIG. 4 is a schematic perspective view of an ear-hang type headphone device according to the related art;

FIG. 5A is a front view of a headphone device according to a first embodiment of the invention showing an external configuration of the same, and FIG. 5B is a side view of the headphone device;

FIGS. 6A and 6B are schematic illustrations of the headphone device according to the first embodiment of the invention showing an external configuration of the same;

FIGS. 7A and 7B are schematic illustrations of the headphone device according to the first embodiment of the invention showing a mounted state of the same;

FIG. 8 is an illustration of a headphone device to be mounted to an earlobe;

FIGS. 9A and 9B are schematic illustrations of a headphone device according to a second embodiment of the invention showing an external configuration of the same;

FIGS. 10A and 10B are schematic illustrations of a headphone device according to a third embodiment of the invention showing an external configuration of the same;

FIGS. 11A and 11B are schematic illustrations of a headphone device according to a fourth embodiment of the invention showing an external configuration of the same;

FIGS. 12A and 12B are schematic illustrations of a headphone device according to a fifth embodiment of the invention showing an external configuration of the same;

FIGS. 13A and 13B are schematic illustrations of a headphone device according to a sixth embodiment of the invention showing an external configuration of the same; and

FIGS. 14A and 14B are schematic illustrations of a headphone device according to another embodiment of the invention showing an external configuration of the same.

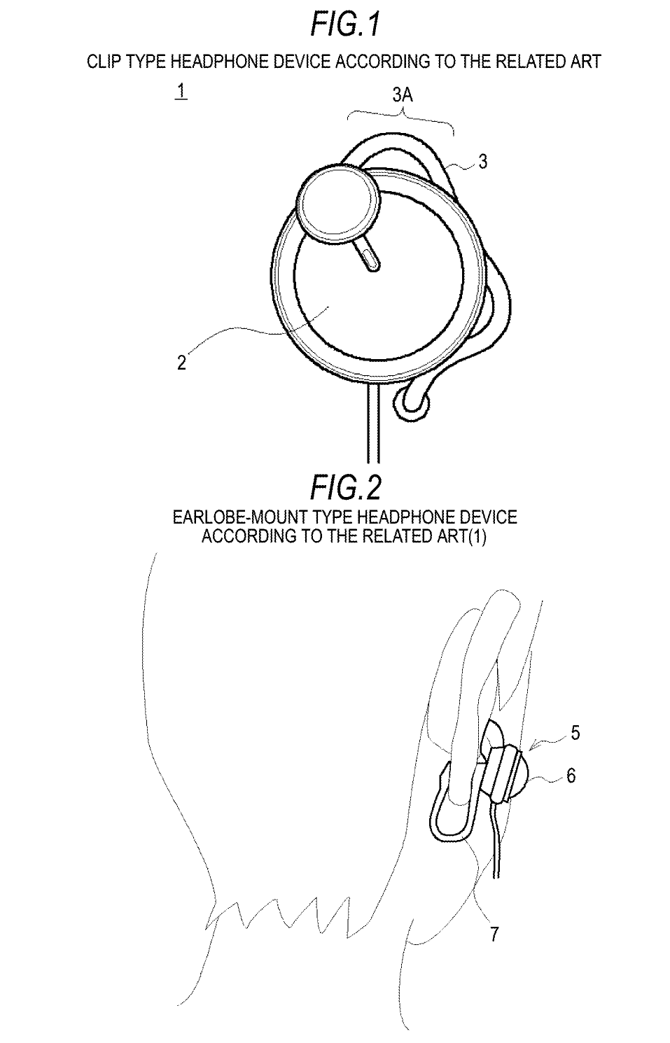

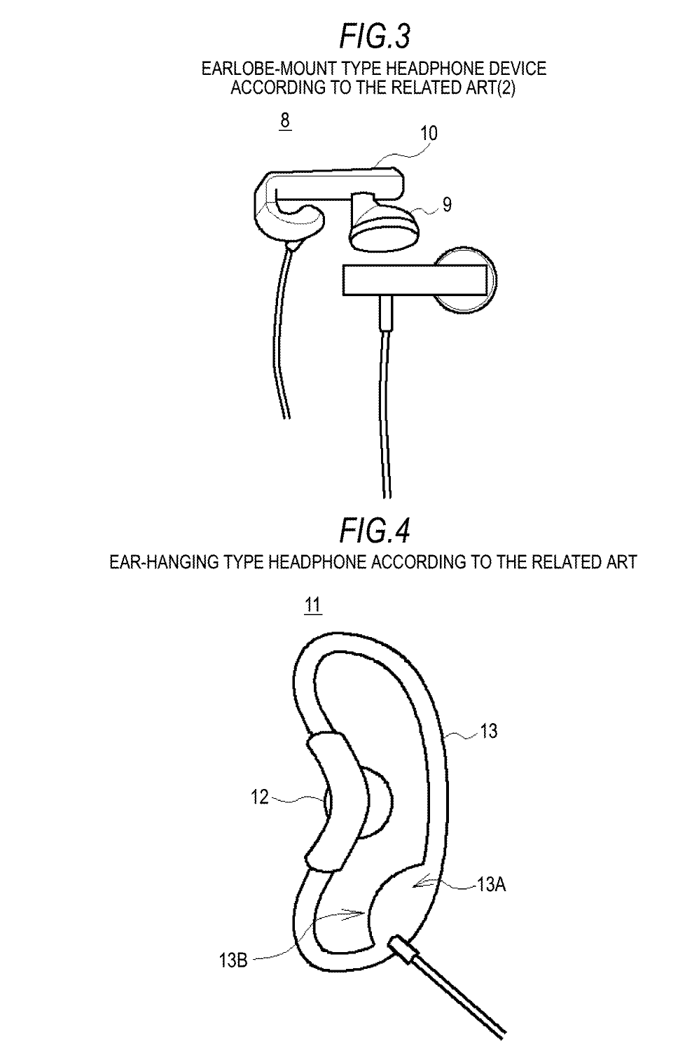

### DESCRIPTION OF PREFERRED EMBODIMENTS

Embodiments of the invention will now be described.

Description will be made in the following order.

1. First Embodiment

2. Second Embodiment

3. Third Embodiment

4. Fourth Embodiment

5. Fifth Embodiment

6. Sixth Embodiment

7. Other Embodiments

### 1. First Embodiment

### 1-1. Configuration of Headphone Device

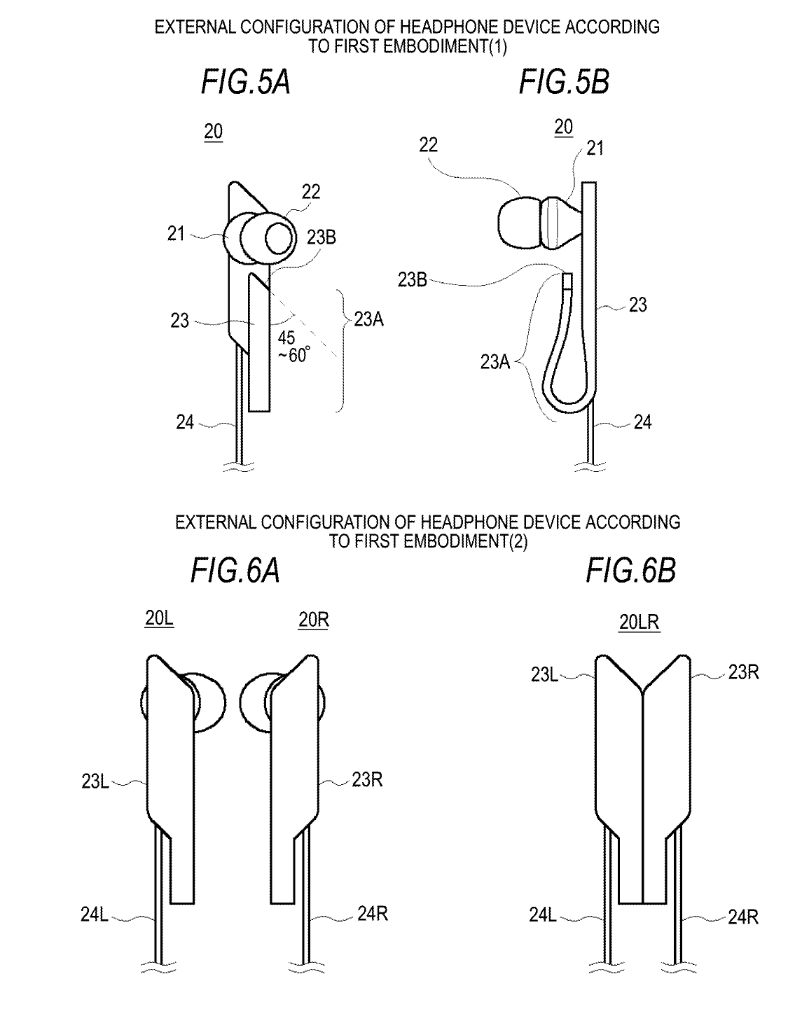

FIG. 5A is a front view of a headphone device 20 according to a first embodiment of the invention, and FIG. 5B is a side view of the headphone device 20.

The headphone device 20 includes an inner ear type driver unit 21, an earpiece 22 attached to an end of the driver unit, and an elongate sheet-like ear-holding section 23 which integrally holds the driver unit 21.

The driver unit 21 and a connection cable 24 are electrically connected in the ear-holding section 23, and the driver unit 21 outputs sounds according to electrical signals supplied from, for example, a portable audio player through the connection cable 24.

The part of the ear-holding section 23 to which the driver unit 21 is attached is in the form of an elongate thin plate, and the section includes an arm 23A which is curved so as to extend toward an end thereof substantially in the form of the character “U”. The ear-holding section 23 is formed such that the arm 23A extends astride an earlobe of a user without touching the earlobe when the device mounted to the ear of the user.

Further, the ear-holding section 23 is formed such that an end 23B of the arm 23A abuts on a recessed part of an auricle at the base of the auricle on the back side thereof. For this purpose, the ear-holding section 23 is formed with a predetermined angle (e.g., an angle in the range from approximately 45 deg to 60 deg) such that the end 23B of the arm 23A can extend like a surface to contact the recessed part of the auricle at the base of the auricle on the back side thereof.

The ear-holding section 23 is an elastic body made of a synthetic resin such as nitryl-butadiene rubber (NBR), silicon rubber, elastomer formed using injection molding, acryl resin, ABS (acrylonitrile butadiene styrene) resin, polypropylene or polybutylene terephthalate.

The arm 23A is also an elastic body made of a synthetic resin such as elastomer, acryl resin, ABS resin, polypropylene or polybutylene terephthalate. Alternatively, the ear-holding section 23 may be formed from a metal, and the arm 23A at an end of the section may be formed from an elastic material.

As a result, the headphone device 20 can feel soft when it is worn by a user with the end 23B of the arm 23A of the ear-holding section 23 abutted on a recessed part of an auricle of the user at the base of the auricle on the back side thereof.

As shown in FIGS. 6A and 6B, an ear-holding section 23L of a headphone device 20L for a left ear and an ear-holding section 23R of a headphone device 20R for a right ear have shapes which are symmetric. The headphone device 20 shown in FIGS. 5A and 5B corresponds to the headphone device 20R shown in FIG. 6A.

When the ear-holding section 23L of the left-ear headphone device 20L and the ear-holding section 23R of the right-ear headphone device 20R are put adjacent to each other, the devices form a unitary shape which makes the devices seem like a unitary body.

As a result, the pair of headphone devices (or a headphone device 20LR) formed by integrating the left-ear headphone device 20L and the right-ear headphone device 20R can be easily carried and used by a user.

### 1-2. Mounted State of Headphone Device

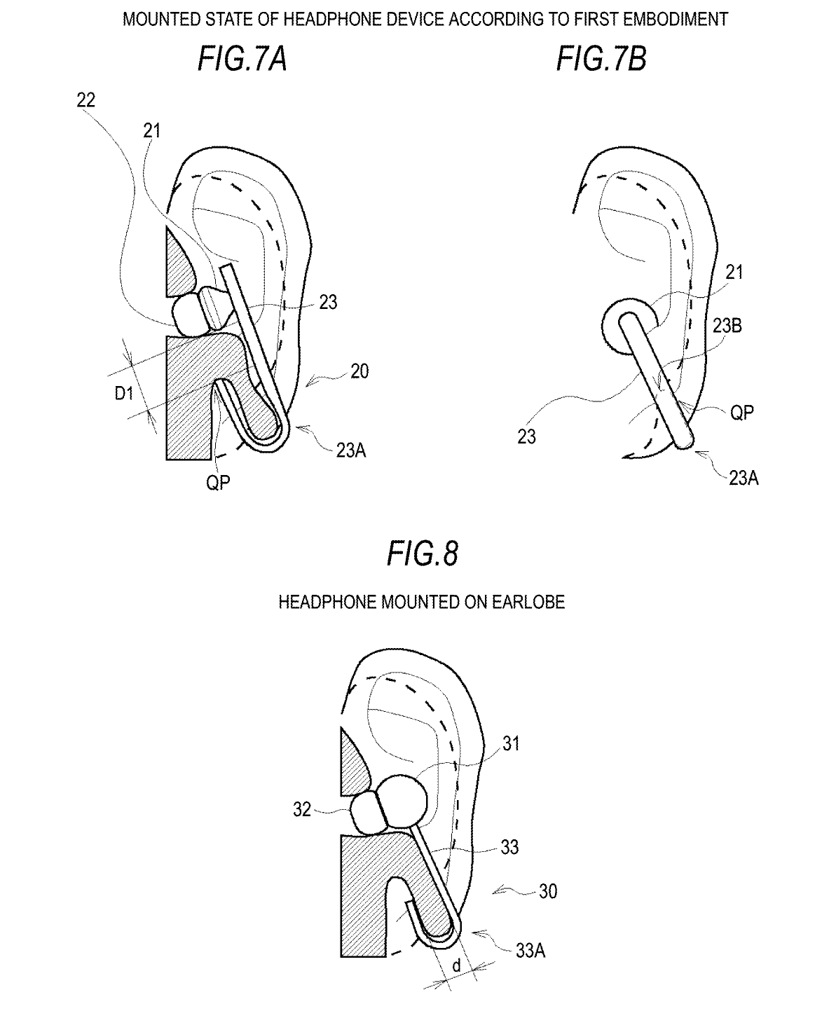

As shown in FIGS. 7A and 7B, when the headphone device 20 is mounted to an ear of a user, the headphone device 20 is held by pushing the earpiece 22 attached to an end of the driver unit 21 into the external acoustic meatus of the auricle.

At this time, the U-curved arm 23A of the ear-holding section 23 of the headphone device 20 is once expanded downward and is thereafter mounted astride the earlobe of the user. Then, the end 23B of the arm 23A abuts on a recessed part QP near the base of the auricle on the back side thereof.

As a result, the headphone device 20 can be mounted to the ear of the user without touching the earlobe by supporting it at two points, i.e., the earpiece 22 and the end 23B of the arm 23A utilizing an urging force acting to restore the expanded arm 23A to the initial state.

At this time, the headphone device 20 pinches the base of the auricle at a gap D1 between the earpiece 22 and the end 23B of the arm 23A.

The gap D1 of the headphone device 20 is much greater than a gap d for pinching an earlobe defined between an arm 33A of an ear-holding section 33 integrally connected with a driver unit 31 of a headphone device 30 which is mounted to an earlobe as shown in FIG. 8.

As a result, the headphone device 20 is firmly held even though it is supported only at two points, i.e., the earpiece 22 and the end 23B of the arm 23A.

Further, since the gap D1 is sufficiently greater than the gap d of the headphone device 30 according to the related art (FIG. 8), a pressure exerted on an earlobe can be kept small to prevent the earlobe from hurting when the headphone device 20 is worn.

### 1-3. Operations and Effects

The headphone device 20 having the above-described configuration is held in place by pushing the earpiece 22 attached to an end of the driver unit 21 into an external acoustic meatus. The headphone device 20 is held with the end 23B of the arm 23A of the ear-holding section 23 abutted on a recessed part QP of the auricle at the base of the auricle on the back side thereof. Thus, the headphone device 20 is mounted to an ear of a user by supporting it at two points, i.e., the earpiece 22 and the end 23B of the arm 23A.

Since the headphone device 20 is mounted with the substantially U-curved arm 23A expanded astride an earlobe of a user, an urging force acts to restore the expanded arm 23A to the initial state. As a result, the headphone device 20 can be firmly mounted to the ear of the user even though it is supported at only two points, i.e., the earpiece 22 and the end 23B of the arm 23A.

In the case of the earlobe-mount type headphone device 30 shown in FIG. 8, since the device is constructed to sandwich an earlobe of a user with the arm 33A of the arm-holding section 33, the user feels a pain because of a pressure exerted by the arm 33A when the device is worn for a long time.

On the contrary, the headphone device 20 is mounted such that the substantially U-curved arm 23A extends astride an earlobe of a user, no pressure is exerted on the earlobe, and the device can therefore be worn comfortably because it gives the user no pain even when used for a long time.

Further, the headphone device 20 can be mounted to an ear of a user without touching the earlobe by supporting it at two points, i.e., the earpiece 22 and the end 23B of the arm 23A utilizing a resilient force of the arm 23A instead of using a structure for pinching the earlobe.

As a result, the headphone device 20 can be easily worn by any user independently of the size of the earlobe, and the device therefore has a significantly wide coverage in terms of users who can wear the same.

In the above-described configuration, the headphone device 20 can be mounted to an ear of a user without touching the earlobe by supporting the device at two points, i.e., the earpiece 22 and the end 23B of the arm 23A utilizing a resilient force of the arm 23A instead of using a structure for pinching the earlobe. Therefore, the headphone device 20 can be worn by any user with a comfortable feel and high stability and without giving a pain.

### 2. Second Embodiment

### 2-1. Configuration of Headphone Device

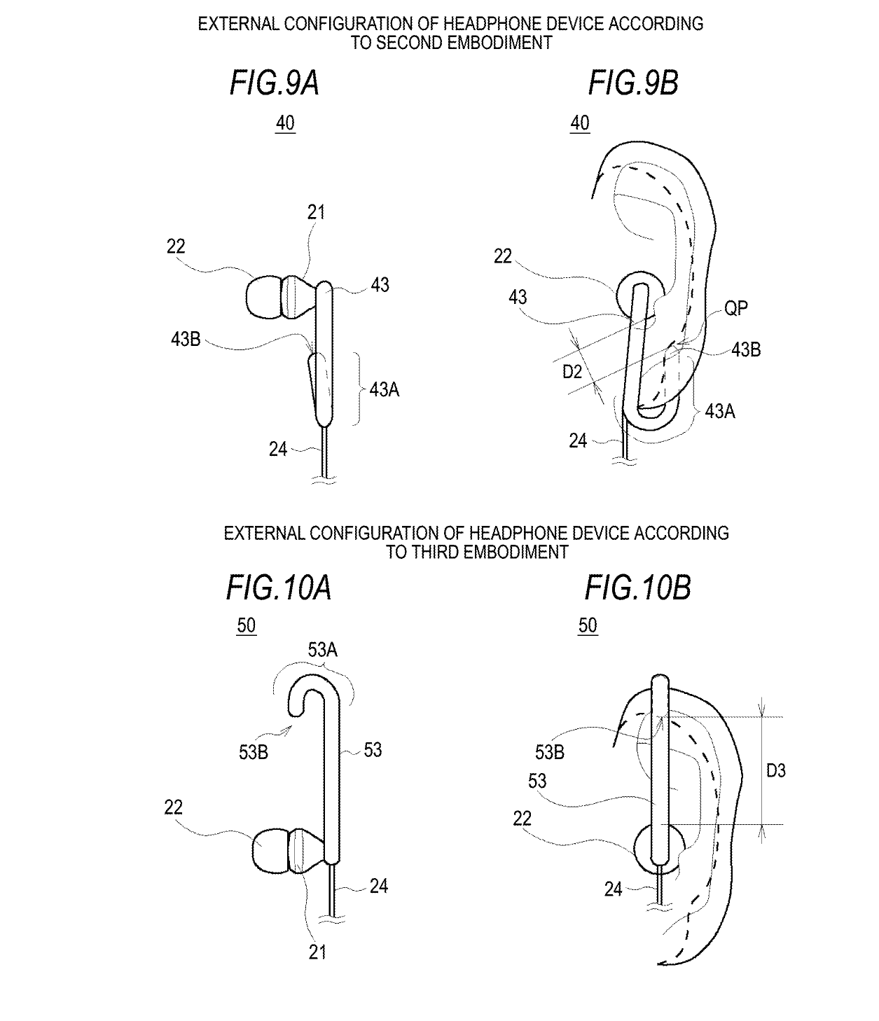

FIG. 9A is a front view of a headphone device 40 according to a second embodiment of the invention, parts identical between FIGS. 9A and 5B being indicated using like reference numerals. FIG. 9B is a view of the headphone device 40 taken when the device is mounted to an ear of a user, parts identical between FIGS. 9B and 7B being indicated using like reference numerals.

The headphone device 40 includes an inner ear type driver unit 21, an earpiece 22 attached to an end of the driver unit, and a substantially U-shaped cylindrical ear-holding section 43 which integrally holds the driver unit 21.

The driver unit 21 and a connection cable 24 are electrically connected in the ear-holding section 43, and the driver unit 21 outputs sounds according to electrical signals supplied from, for example, a portable audio player through the connection cable 24.

The ear-holding section 43 includes an arm 43A which is curved so as to extend toward an end thereof substantially in the form of the character “U”. When the device is mounted to an ear of a user, the arm 43A extends around the earlobe from the front side toward the back side thereof so as to stride across the earlobe without touching the same.

Further, the ear-holding section 43 is formed such that an end 43B of the arm 43A abuts on a recessed part QP of the auricle at the base of the auricle on the back side thereof. For this purpose, the end 43B of the arm 43A of the ear-holding section 43 to be put in contact with the recessed part QP auricle at the base of the auricle on the back side thereof is formed in a semi-spherical shape.

The ear-holding section 43 is an elastic body made of a synthetic resin such as nitryl-butadiene rubber (NBR), silicon rubber, elastomer formed using injection molding, acryl resin, ABS resin, polypropylene or polybutylene terephthalate.

The arm 43A is also an elastic body made of a synthetic resin such as elastomer, acryl resin, ABS resin, polypropylene or polybutylene terephthalate. Alternatively, the ear-holding section 43 may be formed from a metal, and the arm 43A at an end of the section may be formed from an elastic material.

As a result, the headphone device 40 can feel soft when it is worn by a user with the semi-spherically formed end 43B of the arm 43A of the ear-holding section 43 abutted on a recessed part QP of an auricle of the user at the base of the auricle on the back side thereof.

### 2-2. Mounted State of Headphone Device

As shown in FIG. 9B, when the headphone device 40 is mounted to an ear of a user, the headphone device 40 is held by pushing the earpiece 22 attached to an end of the driver unit 21 into the external acoustic meatus of the auricle.

At the same time, the substantially U-curved arm 43A of the ear-holding section 43 of the headphone device 40 is expanded and then mounted around the earlobe of the user such that it extends from the front side toward the back side of the earlobe to stride across the same.

Then, the end 43B of the arm 43A of the headphone device 40 abuts on a recessed part QP of the auricle at the base of the auricle on the back side thereof.

As a result, the headphone device 40 can be mounted to the ear of the user without touching the earlobe by supporting it at two points, i.e., the earpiece 22 and the end 43B of the arm 43A utilizing an urging force acting to restore the expanded arm 43A to the initial state.

At this time, the headphone device 40 pinches the base of the auricle at a gap D2 between the earpiece 22 and the end 43B of the arm 43A.

The gap D2 of the headphone device 40 is much greater than the gap d for pinching an earlobe defined between the arm 33A of the ear-holding section 33 of the headphone device 30 shown in FIG. 8.

As a result, the headphone device 40 is firmly held even though it is supported only at two points, i.e., the earpiece 22 and the end 43B of the arm 43A.

Further, since the gap D2 is sufficiently greater than the gap d of the headphone device 30 according to the related art (FIG. 8), a pressure exerted on an earlobe can be kept small to prevent the earlobe from hurting when the headphone device 40 is worn.

### 2-3. Operations and Effects

The headphone device 40 having the above-described configuration is held in place by pushing the earpiece 22 attached to an end of the driver unit 21 into an external acoustic meatus. The headphone device 40 is held with the end 43B of the arm 43A of the ear-holding section 43 abutted on a recessed part QP of the auricle at the base of the auricle on the back side thereof. Thus, the headphone device 40 is mounted to an ear of a user by supporting it at two points, i.e., the earpiece 22 and the end 43B of the arm 43A.

When the headphone device 40 is mounted by expanding the substantially U-curved arm 43A to allow it to extend astride an earlobe of a user from the front side toward the back side of the earlobe, an urging force acts to restore the expanded arm 43A to the initial state. As a result, the headphone device 40 can be firmly mounted to the ear of the user even though it is supported at only two points, i.e., the earpiece 22 and the end 43B of the arm 43A.

The headphone device 40 is mounted such that the substantially U-curved arm 43A extends astride the earlobe of the user without touching the earlobe from the front side toward the back side thereof.

Thus, the headphone device 40 exerts no pressure on an earlobe of a user and gives the user no pain when the ear-holding section 43 is mounted, and the device can therefore be worn comfortably without a pain even when used for a long time.

Further, the headphone device 40 can be mounted to an ear of a user by supporting it at two points, i.e., the earpiece 22 and the end 43B of the arm 43A utilizing a resilient force of the arm 43A instead of using a structure for pinching the earlobe.

As a result, the headphone device 40 can be easily worn by any user independently of the size of the earlobe, and the device therefore has a significantly wide coverage in terms of users who can wear the same.

In the above-described configuration, the headphone device 40 can be mounted to an ear of a user without touching the earlobe by supporting the device at two points, i.e., the earpiece 22 and the end 43B of the arm 43A utilizing a resilient force of the arm 43A instead of using a structure for pinching the earlobe. Therefore, the headphone device 40 can be worn by any user with a comfortable feel and high stability and without giving a pain.

### 3. Third Embodiment

### 3-1. Configuration of Headphone Device

FIG. 10A is a side view of a headphone device 50 according to a third embodiment of the invention, parts identical between FIGS. 10A and 5B being indicated using like reference numerals.

FIG. 10B is a view of the headphone device 50 taken when the device is mounted to an ear of a user, parts identical between

FIGS. 10B and 7B being indicated using like reference numerals. The headphone device 50 includes an inner ear type driver unit 21, an earpiece 22 attached to an end of the driver unit, and a substantially U-shaped cylindrical ear-holding section 53 which integrally holds the driver unit 21.

The driver unit 21 and a connection cable 24 are electrically connected in the ear-holding section 53, and the driver unit 21 outputs sounds according to electrical signals supplied from, for example, a portable audio player through the connection cable 24.

The ear-holding section 53 includes an arm 53A which is curved so as to extend toward an end thereof substantially in the form of the character “U”. When the device is mounted to an ear of a user, the arm 53A extends astride a top region of the auricle without touching the top region of the auricle.

Further, the ear-holding section 53 is formed such that an end 53B of the arm 53A is put in contact with a part of the auricle near the base thereof, located in the top region of the auricle on the back side thereof. Therefore, the end 53B of the arm 53A of the ear-holding section 53 is formed in a semi-spherical shape to be properly put in contact with the part of the auricle near the base thereof, located in the top region of the auricle on the back side thereof.

The ear-holding section 53 is an elastic body made of a synthetic resin such as nitryl-butadiene rubber (NBR), silicon rubber, elastomer formed using injection molding, acryl resin, ABS resin, polypropylene or polybutylene terephthalate.

The arm 53A is also an elastic body made of a synthetic resin such as elastomer, acryl resin, ABS resin, polypropylene or polybutylene terephthalate. Alternatively, the ear-holding section 53 may be formed from a metal, and the arm 53A at an end of the section may be formed from an elastic material.

As a result, the headphone device 50 can feel soft when it is worn by a user with the semi-spherically formed end 53B of the arm 53A of the ear-holding section 53 abutted on a part of an auricle of the user near the base of the auricle, located in a top region of the auricle on the back side thereof.

### 3-2. Mounted State of Headphone Device

As shown in FIG. 10B, when the headphone device 50 is mounted to an ear of a user, the headphone device 50 is held by pushing the earpiece 22 attached to an end of the driver unit 21 into the external acoustic meatus of the auricle.

At this time, the substantially U-curved arm 53A of the ear-holding section 53 of the headphone device 50 is expanded and then mounted astride a top region of the auricle of the user. Then, the end 53B of the arm 53A abuts on a part of the auricle near the base of the same, located in the top region of the auricle on the back side thereof.

As a result, the headphone device 50 can be mounted to the ear of the user without touching the auricle by supporting it at two points, i.e., the earpiece 22 and the end 53B of the arm 53A utilizing an urging force acting to restore the expanded arm 53A to the initial state.

At this time, the headphone device 50 pinches the base of the auricle in the top region thereof at a gap D3 between the earpiece 22 and the end 53B of the arm 53A.

The gap D3 of the headphone device 50 is much greater than the gap d for pinching an earlobe defined between the arm 33A of the ear-holding section 33 of the headphone device 30 shown in FIG. 8.

As a result, the headphone device 50 is firmly held even though it is supported only at two points, i.e., the earpiece 22 and the end 53B of the arm 53A.

Further, since the gap D3 is sufficiently greater than the gap d of the headphone device 30 according to the related art, a pressure exerted on an auricle can be kept small to prevent the auricle from hurting when the headphone device 50 is worn.

### 3-3. Operations and Effects

The headphone device 50 having the above-described configuration is held in place by pushing the earpiece 22 attached to an end of the driver unit 21 into an external acoustic meatus. The headphone device 50 is held with the end 53B of the arm 53A of the ear-holding section 53 abutted on a part of the auricle near the base thereof, located in a top region of the auricle on the back side thereof. Thus, the headphone device 50 is mounted to an ear of a user by supporting it at two points, i.e., the earpiece 22 and the end 53B of the arm 53A.

When the headphone device 50 is mounted by expanding the substantially U-curved arm 53A to mount it astride a top region of an auricle of a user, an urging force acts to restore the expanded arm 53A to the initial state. As a result, the headphone device 50 can be firmly mounted to the ear of the user even though it is supported at only two points, i.e., the earpiece 22 and the end 53B of the arm 53A.

The headphone device 50 is mounted such that the substantially U-curved arm 53A extends astride the top region of the auricle without touching the earlobe of the user. Thus, the headphone device 50 exerts no pressure on an earlobe of a user and gives the user no pain when the ear-holding section 53 is mounted, and the device can therefore be worn comfortably without a pain even when used for a long time.

Further, the headphone device 50 can be mounted to an ear of a user by supporting it at two points, i.e., the earpiece 22 and the end 53B of the arm 53A utilizing a resilient force of the arm 53A instead of using a structure for pinching the earlobe.

As a result, the headphone device 50 can be easily worn by any user independently of the size of the earlobe, and the device therefore has a significantly wide coverage in terms of users who can wear the same.

In the above-described configuration, the headphone device 50 can be mounted to an ear of a user without touching the earlobe by supporting the device at two points, i.e., the earpiece 22 and the end 53B of the arm 53A utilizing a resilient force of the arm 53A instead of using a structure for pinching the earlobe. Therefore, the headphone device 50 can be worn by any user with a comfortable feel and high stability and without giving a pain.

### 4. Fourth Embodiment

### 4-1. Configuration of Headphone Device

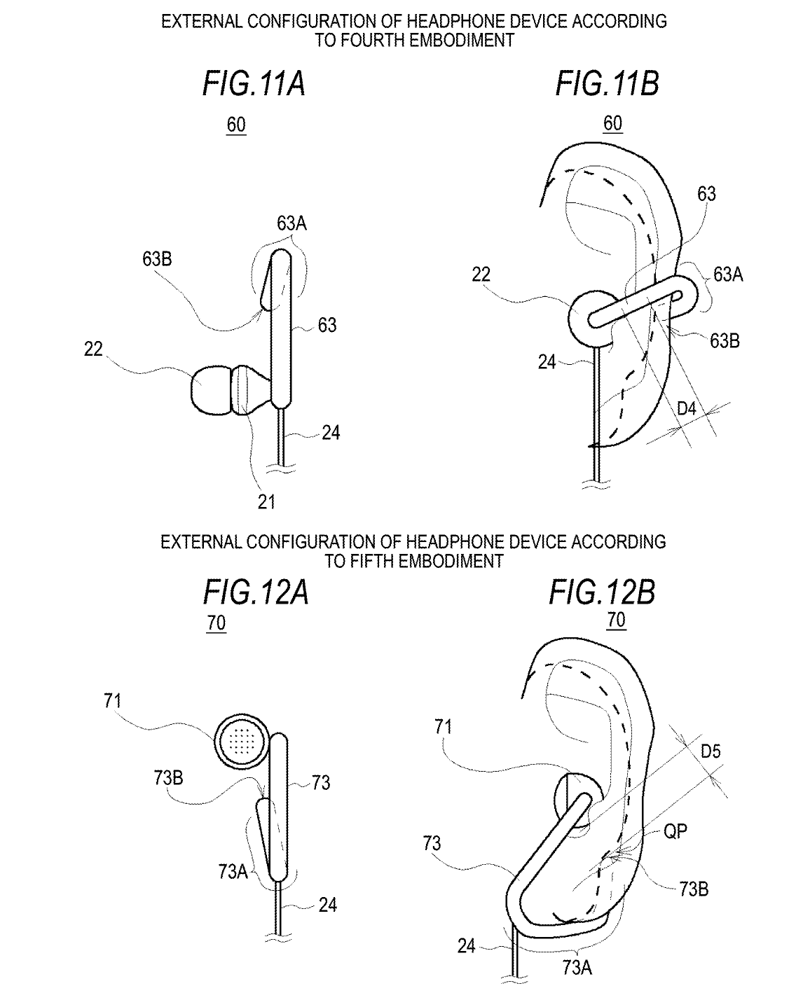

FIG. 11A is a side view of a headphone device 60 according to a fourth embodiment of the invention, parts identical between FIGS. 11A and 5B being indicated using like reference numerals. FIG. 11B is a view of the headphone device 60 taken when the device is mounted to an ear of a user, parts identical between FIGS. 11B and 7B being indicated using like reference numerals.

The headphone device 60 includes an inner ear type driver unit 21, an earpiece 22 attached to an end of the driver unit, and a substantially U-shaped cylindrical ear-holding section 63 which integrally holds the driver unit 21.

The driver unit 21 and a connection cable 24 are electrically connected in the ear-holding section 63, and the driver unit 21 outputs sounds according to electrical signals supplied from, for example, a portable audio player through the connection cable 24.

The ear-holding section 63 includes an arm 63A which is curved so as to extend toward an end thereof substantially in the form of the character “U”. When the device is mounted to an ear of a user, the arm 63A extends astride a side region of the auricle without touching the side region of the auricle.

Further, the ear-holding section 63 is formed such that an end 63B of the arm 63A is put in contact with a part of the auricle near the base thereof, located in a side region of the auricle on the back side thereof. Therefore, the end 63B of the arm 63A of the ear-holding section 63 is formed in a semi-spherical shape to be properly put in contact with the part of the auricle near the base thereof, located in the side region of the auricle on the back side thereof.

The ear-holding section 63 is an elastic body made of a synthetic resin such as nitryl-butadiene rubber (NBR), silicon rubber, elastomer formed using injection molding, acryl resin, ABS resin, polypropylene or polybutylene terephthalate.

The arm 63A is also an elastic body made of a synthetic resin such as elastomer, acryl resin, ABS resin, polypropylene or polypbutylene terephthalate. Alternatively, the ear-holding section 63 may be formed from a metal, and the arm 63A at an end of the section may be formed from an elastic material.

As a result, the headphone device 60 can feel soft when it is worn by a user with the semi-spherically formed end 63B of the arm 63A of the ear-holding section 63 abutted on a part of an auricle of the user near the base of the auricle, located in a side region of the auricle on the back side thereof.

### 4-2. Mounted State of Headphone Device

As shown in FIG. 11B, when the headphone device 60 is mounted to an ear of a user, the headphone device 60 is held by pushing the earpiece 22 attached to an end of the driver unit 21 into the external acoustic meatus of the auricle.

At this time, the substantially U-curved arm 63A of the ear-holding section 63 of the headphone device 60 is expanded and then mounted astride a side region of the auricle of the user. Then, the end 63B of the arm 63A abuts on a part of the auricle near the base thereof, located in the side region of the auricle on the back side of thereof.

As a result, the headphone device 60 can be mounted to the ear of the user without touching the auricle by supporting it at two points, i.e., the earpiece 22 and the end 63B of the arm 63A utilizing an urging force acting to restore the expanded arm 63A to the initial state.

At this time, the headphone device 60 pinches the base of the auricle in the side region on the back side of the auricle at a gap D4 between the earpiece 22 and the end 63B of the arm 63A.

The gap D4 of the headphone device 60 is greater than the gap d for pinching an earlobe defined between the arm 33A of the ear-holding section 33 integrally held with the driver unit 31 of the headphone device 30 shown in FIG. 8.

As a result, the headphone device 60 is firmly held even though it is supported only at two points, i.e., the earpiece 22 and the end 63B of the arm 63A.

Further, since the gap D4 is sufficiently greater than the gap d of the headphone device 30 according to the related art, a pressure exerted on an auricle can be kept small to prevent the auricle from hurting when the headphone device 60 is worn.

### 4-3. Operations and Effects

The headphone device 60 having the above-described configuration is held in place by pushing the earpiece 22 attached to an end of the driver unit 21 into an external acoustic meatus. The headphone device 60 is held with the end 63B of the arm 63A of the ear-holding section 63 abutted on a part of the auricle near the base thereof, located in a side region of the auricle on the back side thereof. Thus, the headphone device 60 is mounted to an ear of a user by supporting it at two points, i.e., the earpiece 22 and the end 63B of the arm 63A.

When the headphone device 60 is mounted by expanding the substantially U-curved arm 63A to mount it astride a side region of an auricle of a user, an urging force acts to restore the expanded arm 63A to the initial state. As a result, the headphone device 60 can be firmly mounted to the ear of the user even though it is supported at only two points, i.e., the earpiece 22 and the end 63B of the arm 63A.

The headphone device 60 is mounted such that the substantially U-curved arm 63A extends astride the side region of the auricle without touching the earlobe of the user.

Thus, the headphone device 60 exerts no pressure on an earlobe of a user and gives the user no pain when the ear-holding section 63 is mounted, and the device can therefore be worn comfortably without a pain even when used for a long time.

Further, the headphone device 60 can be mounted to an ear of a user by supporting it at two points, i.e., the earpiece 22 and the end 63B of the arm 63A utilizing a resilient force of the arm 63A instead of using a structure for pinching the earlobe.

As a result, the headphone device 60 can be easily worn by any user independently of the size of the earlobe, and the device therefore has a significantly wide coverage in terms of users who can wear the same.

In the above-described configuration, the headphone device 60 can be mounted to an ear of a user without touching the earlobe by supporting the device at two points, i.e., the earpiece 22 and the end 63B of the arm 63A utilizing a resilient force of the arm 63A instead of using a structure for pinching the earlobe. Therefore, the headphone device 60 can be worn by any user with a comfortable feel and high stability and without giving a pain.

### 5. Fifth Embodiment

### 5-1. Configuration of Headphone Device

FIG. 12A is a front view of a headphone device 70 according to a fifth embodiment of the invention, parts identical between FIGS. 12A and 5A being indicated using like reference numerals. FIG. 12B is a view of the headphone device 70 taken when the device is mounted to an ear of a user, parts identical between FIGS. 12B and 7B being indicated using like reference numerals.

The headphone device 70 includes a driver unit 71 and a cylindrical ear-holding section 73 which integrally holds the driver unit 71 and which is substantially formed like a hook.

The driver unit 71 is a vertical type driver which is to be mounted so as to output sounds toward an eardrum. The driver unit 71 is pushed into an external acoustic meatus such that sounds from the driver are output toward the eardrum.

The driver unit 71 and a connection cable 24 are electrically connected in the ear-holding section 73, and the driver unit 71 outputs sounds according to electrical signals supplied from, for example, a portable audio player through the connection cable 24.

The ear-holding section 73 includes an arm 73A which is curved so as to extend toward an end thereof substantially in the form of a hook. When the device is mounted to an ear of a user, the arm 73A extends around the earlobe from the front side toward the back side of the same to stride across the earlobe without touching the earlobe.

Further, the ear-holding section 73 is formed such that an end 73B of the arm 73A abuts on a recessed part QP of an auricle at the base thereof, located in a side region of the auricle on the back side thereof. Therefore, the end 73B of the arm 73A of the ear-holding section 73 is formed in a semi-spherical shape to be properly put in contact with the recessed part QP of the auricle at the base thereof, located in a side region of the auricle on the back side thereof.

The ear-holding section 73 is an elastic body made of a synthetic resin such as nitryl-butadiene rubber (NBR), silicon rubber, elastomer formed using injection molding, acryl resin, ABS resin, polypropylene or polybutylene terephthalate.

The arm 73A is also an elastic body made of a synthetic resin such as elastomer, acryl resin, ABS resin, polypropylene or polybutylene terephthalate. Alternatively, the ear-holding section 73 may be formed from a metal, and the arm 73A at an end of the section may be formed from an elastic material.

As a result, the headphone device 70 can feel soft when it is worn by a user with the semi-spherically formed end 73B of the arm 73A of the ear-holding section 73 abutted on a recessed part QP of an auricle at the base thereof, located in a side region of the auricle on the backside thereof.

### 5-2. Mounted State of Headphone Device

As shown in FIG. 12B, when the headphone device 70 is mounted to an ear of a user, the headphone device 70 is held by pushing the driver unit 71 directly into the external acoustic meatus.

At the same time, the substantially hook-like curved arm 73A of the ear-holding section 73 of the headphone device 70 is expanded and then mounted astride the earlobe of the user so as to extend around the earlobe from front side toward the back side thereof. Then, the end 73B of the arm 73A of the headphone device 70 abuts on a part QP of the auricle at the base thereof, located in a side region of the auricle on the back side thereof.

As a result, the headphone device 70 can be mounted to the ear of the user without touching the earlobe by supporting it at two points, i.e., the driver unit 71 and the end 73B of the arm 73A utilizing an urging force acting to restore the expanded arm 73A to the initial state.

At this time, the headphone device 70 pinches the base of the auricle at a gap D5 between the driver unit 71 and the end 73B of the arm 73A.

The gap D5 of the headphone device 70 is much greater than the gap d for pinching an earlobe defined between the arm 33A of the ear-holding section 33 of the headphone device 30 shown in FIG. 8.

As a result, the headphone device 70 is firmly held even though it is supported only at two points, i.e., the driver unit 71 and the end 73B of the arm 73A.

Further, since the gap D5 is sufficiently greater than the gap d of the headphone device 30 according to the related art, a pressure exerted on an auricle can be kept small to prevent the auricle from hurting when the headphone device 70 is worn.

### 5-3. Operations and Effects

The headphone device 70 having the above-described configuration is held in place by pushing the driver unit 71 into an external acoustic meatus. The headphone device 70 is held with the end 73B of the arm 73A of the ear-holding section 73 abutted on a recessed part QP of the auricle at the base thereof, located in a side region of the auricle and on the back side thereof. Thus, the headphone device 70 is mounted to an ear of a user by supporting it at two points, i.e., the driver unit 71 and the end 73B of the arm 73A.

When the headphone device 70 is mounted by expanding the substantially hook-like curved arm 73A to mount it astride an earlobe of a user such that it extends around the earlobe from a front side toward the back side of the same, an urging force acts to restore the expanded arm 73A to the initial state. As a result, the headphone device 70 can be firmly mounted to the ear of the user even though it is supported at only two points, i.e., the driver unit 71 and the end 73B of the arm 73A.

The headphone device 70 is mounted such that the substantially hook-like curved arm 73A extends around the earlobe of the user from the front side toward the back side thereof so as to stride across the earlobe without touching the same.

Thus, the headphone device 70 exerts no pressure on an earlobe of a user and gives the user no pain when the ear-holding section 73 is mounted, and the device can therefore be worn comfortably without a pain even when used for a long time.

Further, the headphone device 70 can be mounted to an ear of a user by supporting it at two points, i.e., the driver unit 71 and the end 73B of the arm 73A utilizing a resilient force of the arm 73A instead of using a structure for pinching the earlobe.

As a result, the headphone device 70 can be easily worn by any user independently of the size of the earlobe, and the device therefore has a significantly wide coverage in terms of users who can wear the same.

In the above-described configuration, the headphone device 70 can be mounted to an ear of a user without touching the earlobe by supporting the device at two points, i.e., the driver unit 71 and the end 73B of the arm 73A utilizing a resilient force of the arm 73A instead of using a structure for pinching the earlobe. Therefore, the headphone device 70 can be worn by any user with a comfortable feel and high stability and without giving a pain.

### 6. Sixth Embodiment

### 6-1. Configuration of Headphone Device

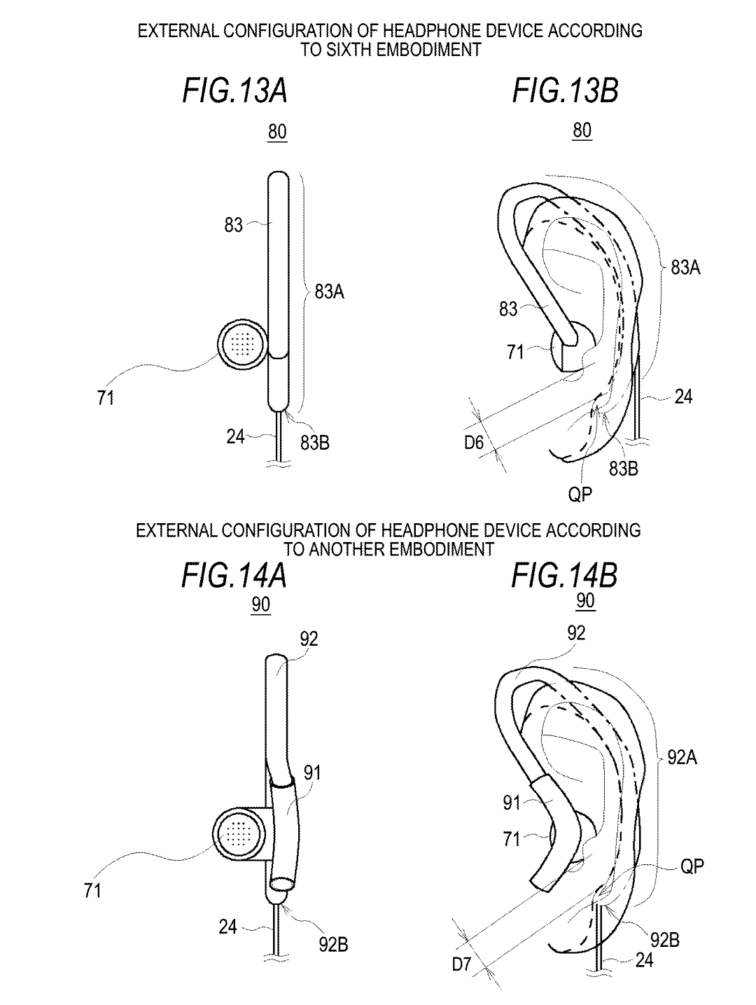

FIG. 13A is a front view of a headphone device 80 according to a sixth embodiment of the invention, parts identical between FIGS. 13A and 12A being indicated using like reference numerals. FIG. 13B is a view of the headphone device 80 taken when the device is mounted to an ear of a user, parts identical between FIGS. 13B and 12B being indicated using like reference numerals.

The headphone device 80 includes a driver unit 71 and a cylindrical ear-holding section 83 which integrally holds the driver unit 71 and which is substantially formed like an inverted hook.

The driver unit 71 is a vertical type driver which is to be mounted so as to output sounds toward an eardrum. The driver unit 71 is pushed into an external acoustic meatus such that sounds from the driver are output toward the eardrum.

The driver unit 71 and a connection cable 24 are electrically connected in the ear-holding section 83, and the driver unit 71 outputs sounds according to electrical signals supplied from, for example, a portable audio player through the connection cable 24.

The ear-holding section 83 includes an arm 83A which is curved so as to extend toward an end thereof substantially in the form of an inverted hook. When the device is mounted to an ear of a user, the arm 83A extends around the earlobe from an upper front region toward a lower back region of the earlobe to stride across the earlobe without touching the earlobe.

Further, the ear-holding section 83 is formed such that an end 83B of the arm 83A abuts on a recessed part QP of an auricle at the base thereof on the back side of the auricle. Therefore, the end 83B of the arm 83A of the ear-holding section 83 is formed in a semi-spherical shape to be properly put in contact with the recessed part QP of the auricle at the base thereof on the back side of the auricle.

The ear-holding section 83 is an elastic body made of a synthetic resin such as nitryl-butadiene rubber (NBR), silicon rubber, elastomer formed using injection molding, acryl resin, ABS resin, polypropylene or polybutylene terephthalate.

The arm 83A is also an elastic body made of a synthetic resin such as elastomer, acryl resin, ABS resin, polypropylene or polybutylene terephthalate. Alternatively, the ear-holding section 83 may be formed from a metal, and the arm 83A at an end of the section may be formed from an elastic material.

As a result, the headphone device 80 can feel soft when it is worn by a user with the semi-spherically formed end 83B of the arm 83A of the ear-holding section 83 abutted on a recessed part QP of the auricle at the base thereof on the back side of the auricle.

### 6-2. Mounted State of Headphone Device

As shown in FIG. 13B, when the headphone device 80 is mounted to an ear of a user, the headphone device 80 is held by pushing the driver unit 71 directly into the external acoustic meatus.

At the same time, the substantially inverted-hook-like curved arm 83A of the ear-holding section 83 of the headphone device 80 is expanded and then mounted astride the earlobe of the user such that it extends around the earlobe from an upper front region toward a lower back region of the same. Then, the end 83B of the arm 83A of the headphone device 80 abuts on a recessed part QP of the auricle at base thereof on the back side of the auricle.

As a result, the headphone device 80 can be mounted to the ear of the user without touching the earlobe by supporting it at two points, i.e., the driver unit 71 and the end 83B of the arm 83A utilizing an urging force acting to restore the expanded arm 83A to the initial state.

At this time, the headphone device 80 pinches the base of the auricle at a gap D6 between the driver unit 71 and the end 83B of the arm 83A.

The gap D6 of the headphone device 80 is much greater than the gap d for pinching an earlobe defined between the arm 33A of the ear-holding section 33 of the headphone device 30 shown in FIG. 8.

As a result, the headphone device 80 is firmly held even though it is supported only at two points, i.e., the driver unit 71 and the end 83B of the arm 83A.

Further, since the gap D6 is sufficiently greater than the gap d of the headphone device 30 according to the related art, a pressure exerted on an auricle can be kept small to prevent the auricle from hurting when the headphone device 80 is worn.

### 6-3. Operations and Effects

The headphone device 80 having the above-described configuration is held in place by pushing the driver unit 71 into an external acoustic meatus. The headphone device 80 is held with the end 83B of the arm 83A of the ear-holding section 83 abutted on a recessed part QP of the auricle at the base of the auricle on the back side of thereof. Thus, the headphone device 80 is mounted to an ear of a user by supporting it at two points, i.e., the driver unit 71 and the end 83B of the arm 83A.

When the headphone device 80 is mounted by expanding the substantially inverted-hook-like curved arm 83A to mount it astride an earlobe of a user such that it extends around the earlobe from a front side toward the back side of the same, an urging force acts to restore the expanded arm 83A to the initial state. As a result, the headphone device 80 can be firmly mounted to the ear of the user even though it is supported at only two points, i.e., the driver unit 71 and the end 83B of the arm 83A.

The headphone device 80 is mounted such that the substantially inverted-hook-like curved arm 83A extends around the earlobe of the user from an upper front region toward a lower back region thereof so as to stride across the earlobe without touching the same.

Thus, the headphone device 80 exerts no pressure on an earlobe of a user and gives the user no pain when the ear-holding section 83 is mounted, and the device can therefore be worn comfortably without a pain even when used for a long time.

Further, the headphone device 80 can be mounted to an ear of a user by supporting it at two points, i.e., the driver unit 71 and the end 83B of the arm 83A utilizing a resilient force of the arm 83A instead of using a structure for pinching the earlobe.

As a result, the headphone device 80 can be easily worn by any user independently of the size of the earlobe, and the device therefore has a significantly wide coverage in terms of users who can wear the same.

In the above-described configuration, the headphone device 80 can be mounted to an ear of a user without touching the earlobe by supporting the device at two points, i.e., the driver unit 71 and the end 83B of the arm 83A utilizing a resilient force of the arm 83A instead of using a structure for pinching the earlobe. Therefore, the headphone device 80 can be worn by any user with a comfortable feel and high stability and without giving a pain.

### 7. Other Embodiments

The first to sixth embodiments have been described above as instances in which the ear-holding sections 23, 43, 53, 63, 73, and 83 are prevented from touching an earlobe or an auricle of a user. However, the invention is not limited to such instances, and the ear-holding sections may be in direct contact with an earlobe or an auricle.

FIG. 14A is a front view of a headphone device 90 according to another embodiment of the invention, parts identical between

FIGS. 14A and 13A being indicated using like reference numerals. FIG. 13B is a view of the headphone device 90 taken when the device is mounted to an ear of a user, parts identical between FIGS. 14B and 13B being indicated using like reference numerals.

The headphone device 90 includes a driver unit 71, a tubular housing 91 which integrally holds the driver unit 71 and which is substantially formed like an inverted “C”, and a cylindrical ear hanger 92 which is attached to the housing 91 and which is substantially in the form of an inverted hook.

The driver unit 71 is a vertical type driver which is to be mounted so as to output sounds toward an eardrum. The driver unit 71 is pushed into an external acoustic meatus such that sounds from the driver are output toward the eardrum.

The driver unit 71 and a connection cable 24 are electrically connected in the ear hanger 92, and the driver unit 71 outputs sounds according to electrical signals supplied from, for example, a portable audio player through the connection cable 24.

The ear hanger 92 includes an arm 92A which is curved toward an end thereof. When the ear hanger 92 is mounted to an ear of a user, the arm 92A extends around the auricle from an upper front region of the auricle toward a lower rear region of the same. The arm 92A extending from the upper region toward the lower region of the auricle is kept in contact with a region of the head neighboring the base of the auricle on the back side thereof.

Further, an end 92B of the arm 92A of the ear hanger 92 abuts on a recessed part QP of the auricle at the base of the auricle on the back side thereof. For this reason, the end 92B of the arm 92A of the ear hanger 92 to be put in contact with the recessed part QP of the auricle at the base of the auricle on the back side thereof is formed in a semi-spherical shape.

The ear hanger 92 is an elastic body made of a synthetic resin such as, elastomer formed using injection molding, acryl resin, ABS resin, polypropylene or polybutylene terephthalate.

The arm 92A is also an elastic body made of a synthetic resin such as elastomer, acryl resin, ABS resin, polypropylene or polybutylene terephthalate. Alternatively, the ear hanger 92 may be formed from a metal, and the arm 92A at an end of the section may be formed from an elastic material.

As a result, the headphone device 90 can feel soft when it is worn by a user with the semi-spherically formed the end 92B of the arm 92A of the ear hanger 92 abutted on a recessed part QP of an auricle of at the base of the auricle on the back side thereof.

In practice, when the headphone device 90 is mounted to an ear of a user, the headphone device 90 is held by pushing the driver unit 71 directly into the external acoustic meatus. At the same time, the substantially inverted-hook-like curved arm 92A of the ear hanger 92 of the headphone device 90 is expanded and then mounted astride the earlobe of the user such that it extends around the earlobe from an upper front region toward a lower back region of the same.

Then, the end 92B of the arm 92A of the headphone device 90 abuts on a recessed part QP of the auricle at the base of the auricle on the back side thereof with the arm 92A as a whole kept extending along a region of the head neighboring the base of the auricle on the back side thereof in contact with the region.

As a result, the headphone device 90 can be kept mounted on the ear of the user not only by the support provided at the two points, i.e., the driver unit 71 and the end 92B of the arm 92A but also by the arm 92A which extends along the region neighboring the base of the auricle on the back side thereof such that a surface of the arm extending the entire length thereof is kept in contact with the region.

At this time, the headphone device 90 pinches the base of the auricle at a gap D7 between the driver unit 71 and the end 92B of the arm 92A.

The gap D7 of the headphone device 90 is much greater than the gap d for pinching an earlobe defined between the arm 33A of the ear-holding section 33 of the headphone device 30 shown in FIG. 8.

As a result, the headphone device 90 is firmly held even if it is supported only at two points, i.e., the driver unit 71 and the end 92B of the arm 92A.

Further, since the gap D7 is sufficiently greater than the gap d of the headphone device 30 according to the related art, a pressure exerted on an auricle can be kept small to prevent the auricle from hurting when the headphone device 90 is worn.

The headphone device 90 is held in place by pushing the driver unit 71 into an external acoustic meatus and abutting the end 92B of the arm 92A of the ear hanger 92 on a recessed part QP of the auricle at the base of the auricle on the back side thereof. In addition, the device is held in place by the arm 92A which extends along a region neighboring the base of the auricle on the back side thereof with a surface of the arm extending the entire length thereof kept in contact with the region.

As a result, the headphone device 90 can be mounted to an ear of a user with improved fit.

When the headphone device 90 is mounted, the arm 92A of the ear hanger 92 strides across the auricle of the user without touching the same, and the arm extends from an upper front region toward a lower rear region of the auricle along a region of the head neighboring the base of the auricle on the back side thereof in contact with the same.

Thus, the headphone device 90 exerts no pressure on an earlobe of a user and gives the user no pain when the ear hanger 92 is mounted, and the device can therefore be worn comfortably without a pain even when used for a long time.

Further, the headphone device 90 can be mounted to an ear of a user by supporting it by the driver unit 71, the entire body of the arm 92A, and the end 92B of the arm 92A utilizing a resilient force of the arm 92A instead of using a structure for pinching the earlobe. As a result, the headphone device 90 can be easily worn by any user independently of the size of the earlobe, and the device can therefore be provided with a significantly wide coverage in terms of users who can wear the same.

In the above-described first to sixth embodiments, the arms 23A, 33A, 43A, 53A, and 63A are elastic bodies made of a synthetic resin such as elastomer, acryl resin, ABS resin, polypropylene or polybutylene terephthalate.

The invention is not limited to such materials, and other materials including metals may be used as long as the ends 23B, 43B, 53B, and 63B of the arms 23A, 33A, 43A, 53A, and 63A feel soft for a user when they are made to abut on a recessed part QP of an auricle at the base of the auricle on the back side thereof.

The first embodiment has been described as an instance in which the ear-holding section 23 is formed such that the arm 23A extends at a predetermined angle (e.g., an angle in the range from approximately 45 deg to 60 deg) to allow the end 23B of the arm 23A to make surface contact with a recessed part QP of an auricle at the base the auricle on the back side thereof. However, the invention is not limited such an instance, and the section may be formed at a different angle, and it may still alternatively be formed in a spherical shape.

The first to sixth embodiments have been described as instances in which the ends 23B, 43B, 53B, and 63B of the arms 23A, 33A, 43A, 53A, and 63A are made to feel soft when the devices are worn by a user by forming the ends at a predetermined angle (e.g., about 45 deg) to allow the ends to make surface contact with a recessed part QP of an auricle at the base of the auricle on the back side thereof or by or forming the ends in a spherical shape. However, the invention is not limited to such instances, and a cover made of sponge or rubber may be provided on the end 23B, 43B, 53B or 63B such that it feels soft when the device is worn by a user.

The first to fourth embodiments have been described as instances in which the inner-ear type driver unit 21 is used. However, the invention is not limited to such instances, and a vertical type driver unit or a lateral type driver unit may alternatively be used.

The fifth and sixth embodiments have been described as instances in which a vertical type driver unit is used. However, the invention is not limited to such instances, and an inner-ear type driver unit or a lateral type driver unit may alternatively be used.

The first to sixth embodiment have been described above as instances in which a headphone device is connected to a portable audio player through a connection cable 24. However, the invention is not limited to such instances, and the headphone devices 20, 40, 50, 60, 70, and 80 may be radio-connected to a portable audio player using a radio system according to Bluetooth (registered trademark).

A headphone device according to an embodiment of the invention may be used by connecting it to a portable audio player. The invention may alternatively be applied to headphone devices used by being connected to various types of electronic apparatus such as mobile telephones, PDAs (personal digital assistants), notebook type personal computers, game machines, and home audio apparatus.

The present application contains subject matter related to that disclosed in Japanese Priority Patent Application JP 2009-162941 filed in the Japan Patent Office on Jul. 9, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A headphone device comprising:
a driver unit held in a vicinity of an external acoustic meatus of an ear; and
an arm in a predetermined shape formed integrally with the driver unit and extending from the driver unit, wherein
an end of the arm is kept abutting on a part of an auricle that is near a base of the auricle on a back side of the auricle so as to support the device at two support points provided by the driver unit and the end of the arm.

2. A headphone device according to claim 1, wherein the end of the arm abuts on the base of the auricle on the back side of the auricle.

3. A headphone device according to claim 2, wherein the end of the arm abuts on a recessed part of the base of the auricle on the back side of the auricle.

4. A headphone device according to claim 3, wherein the arm is curved in a predetermined shape such that the arm strides across the auricle or an earlobe of the ear.
